(19) United States
(12) Patent Application Publication
(10) Pub. No.: US 2020/0129354 A1
(43) Pub. Date: Apr. 30, 2020

(54) POOL LIFT FOR THE AUTONOMOUS ACCESS TO A POOL OF WHEELCHAIR USERS AND PERSONS WITH REDUCED MOBILITY

(71) Applicant: NIKOLAOS IOANNOU, ATHENS (GR)

(72) Inventor: NIKOLAOS IOANNOU, ATHENS (GR)

(21) Appl. No.: 16/621,929

(22) PCT Filed: Jun. 15, 2018
(86) PCT No.: PCT/GR2018/000027

§ 371 Date: Dec. 12, 2019

(30) Foreign Application Priority Data
Jun. 16, 2017 (GR) 20170100273

(51) Int. Cl. A61G 7/10

(52) U.S. Cl. CPC A61G 7/1005; A61G 5/104; A61G 7/1019

(57) ABSTRACT

Pool access lift, for wheelchair users or persons with reduced mobility who cannot use the ladder. The lift interfaces with the edge of the pool and operates in vertical movement, bringing users to a buoyancy condition. It may be used by wheelchair users (access is possible while the user is in the wheelchair and does not need to change seat). When ascending, the user may return to the wheelchair and rise to the level of the surrounding area, without any help from qualified operators of any machinery. —It provides autonomy to users, who do not need further assistance in relation to any of their transports. Autonomy is very important to people with reduced mobility. —It is anchored outside the pool. Thus, the pool must not be emptied (which considerably saves money and time, with particular reference to hotels).

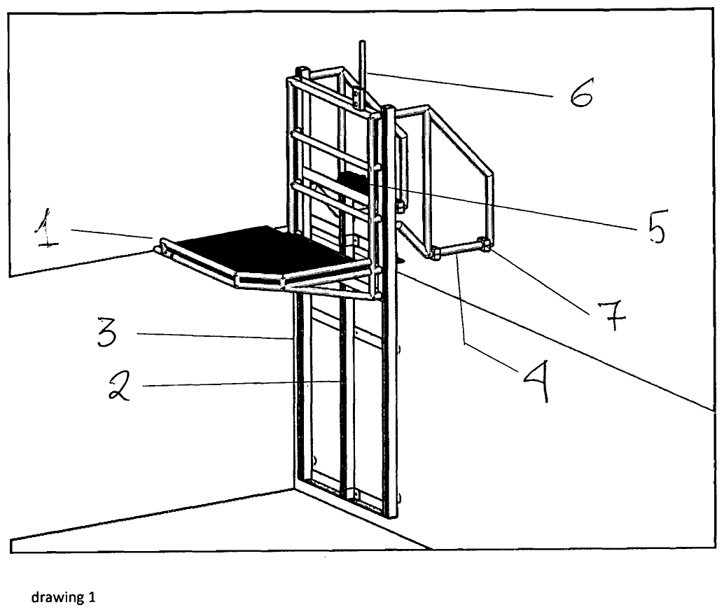

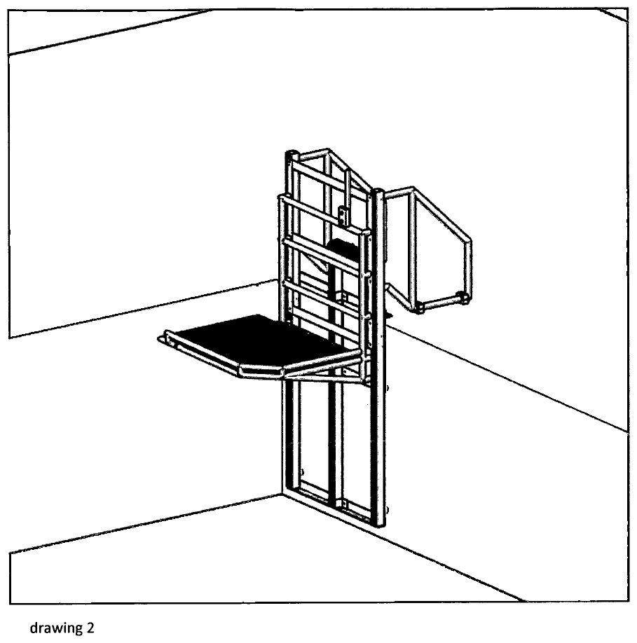

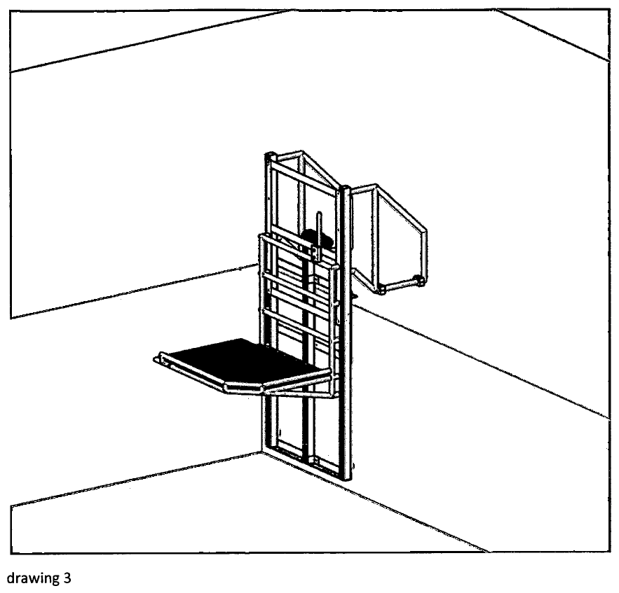

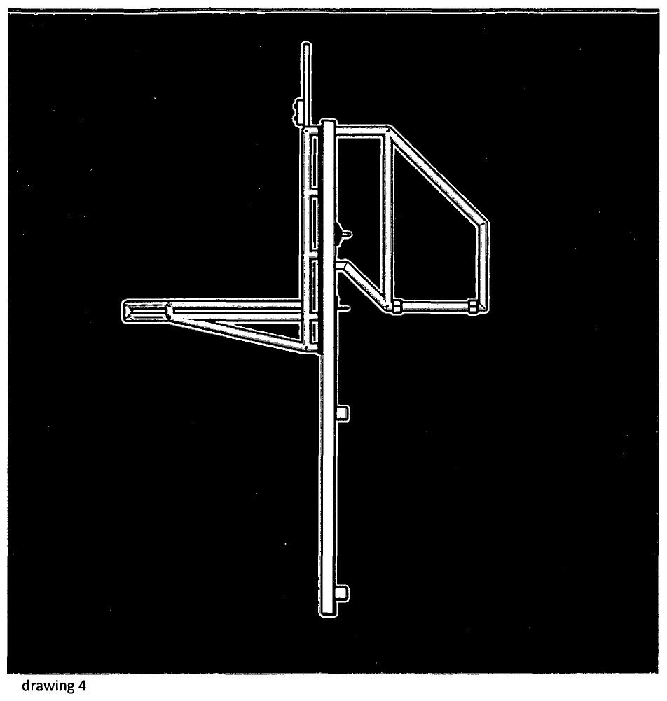

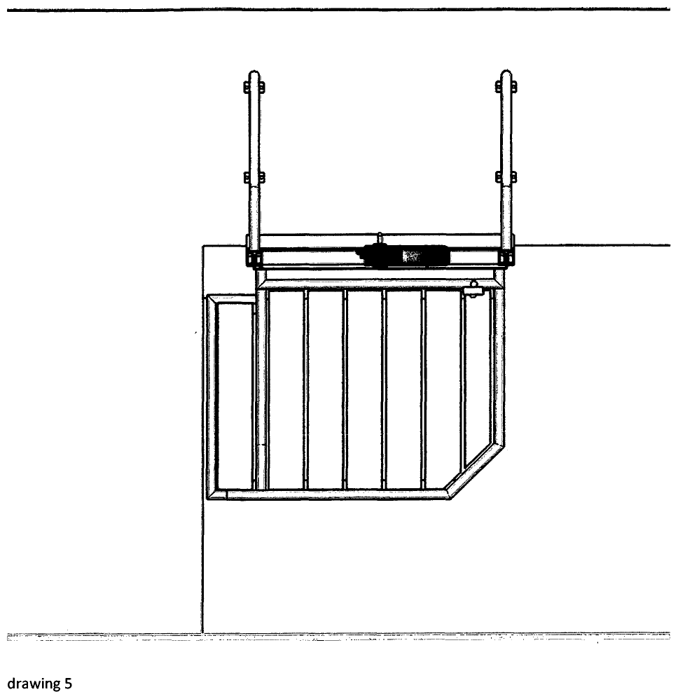

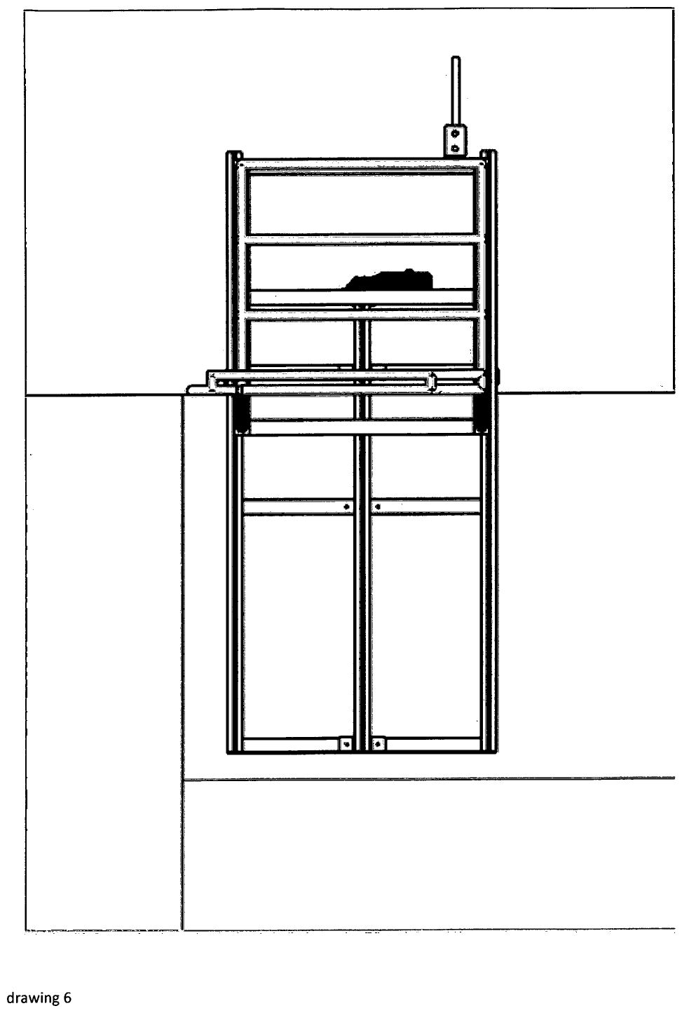

This invention refers to a persons' lift, which offers autonomous, easy and safe access to the pool to persons with reduced mobility (wheelchair users or persons who have difficulty in walking and use a cane, crutches or a walker).

The products—mechanisms available on the market are designed in such a way that the user may sit on a hovering chair suspended by a crane.

The mechanism is handled by another person assistant, who knows how to handle it. This means another relatively qualified person must always be present to help the user who consequently depends on the presence of the machine operator.

The user is required to sit on a chair (hence he/she must move from the wheelchair or in case he/she does not use a wheelchair but a cane or crutches instead, he/she must abandon them and sit on the chair of the mechanism). This means the user is not autonomous; he/she needs an assistant and moreover he/she is in the unfortunate situation of floating on air in a seat. After having swum, the user must again get back on the chair and ask the machine operator to lift him/her and return him/her to his/her initial position. Thus the user ceases to be autonomous and self-sufficient in connection to the time and duration of the his/her stay in the water. It must be highlighted that autonomy is of paramount importance for persons with reduced mobility.

These machines are bulky, resemble little cranes and require strong anchoring and opening of a shaft (depending on the model) by the pool. If they are portable, they are deliberately bulky and heavy to be able to lift the user and then bring him/her down into the water safely. Obviously, even in that case, a more qualified operator is required, which means higher cost for example for a hotel that wants to offer such machine to its customers; it also means ongoing reliance of users upon another person.

The advantages of this invention are autonomy for the user, easy and quick installation (it is anchored outside the pool without its emptying being necessary) and usability by other persons as well (like a semi-submerged bench); to prevent the equipment from having the characteristics of equipment exclusively intended for persons with reduced mobility.

In detail

a) the lift (drawing 1) offers autonomous, easy, quick and safe access to the pool to persons with reduced mobility; no further assistance or effort is required in relation to their routine movements.

The level access from the surrounding area allows wheelchair users (a low barrier is installed circumferentially to stop the wheels) as well as users of cane or crutches to move towards the lift.

The waterproof controller is close to the seated user, while rails offer support lengthwise to standing users.

The vertical and smooth movement easily and safely brings the user into the water in a buoyancy state and allows him/her to function at will in the water in accordance with his-her motor skills.

Without needing an assistant operator for any machine, which creates feelings of dependence and discomfort (sitting on a hovering chair causes a sensation of insecurity and discomfort), the user can enjoy his/her swim easily and pleasantly.

b) The design of the lift ensures quick and easy installation.

Its form and the application of the force of gravity of its bearing elements, as well as of the person(s) using it, allow its anchoring outside the pool with the mounting bases (7), without requiring anchoring inside the pool or without needing to empty the water for any work to be performed inside it.

This is very important for any interested buyer.

It saves a lot of money and possible waste of water (especially on the islands where water is precious and very expensive); it also saves pool operating time.

c) Use by other persons too.

The machinery and equipment addressed to persons with reduced mobility usually resembles “hospital” equipment and their use is exclusively intended for such persons.

In this case, the platform may also be used by persons without disabilities in order to either descend into the water or use it as a bench. Submerged by 20-25 cm it may accommodate any other person that simply wishes to sit semi-submerged into the water to relax. The said use of the equipment proves that the equipment is not exclusively intended for persons with reduced mobility. It may be considered a toy everyone can use. This aspect is also particularly important and useful for the appearance and aesthetics of the pool, the surrounding area and also the mood of the actual users of the lift, as the equipment is not exclusively installed for them.

The pool lift offers direct level access to the platform from the surrounding area of the pool to persons with reduced mobility. Users simply step on the platform, which is in contact with the edge of the pool, and by using the controller (6) they vertically descend below water surface, thus entering a buoyancy state.

In the event of a wheelchair user, he/she can have access to the platform in the same way he/she moves in his/her other activities, and he/she may use the lift on his/her own as a vertically moving elevator.

The same applies for persons with reduced mobility (cane or crutches users) who do not use a wheelchair but cannot enter the pool from the ladder.

The platform (1) with the integrated, vertically moving, rail

is connected to an endless drive screw (2), which is driven by an electric motor (5) and may raise-lower the platform safely, slowly and vibration-free.

The endless screw is included in a stainless steel metal hollow section (2), which provides support safety, avoidance of contact with other objects and is the base plate for the motor and its reducer.

The vertical movement of the platform is guaranteed by properly manufactured stainless steel hollow sections (3) supporting the platform, in which rollers and motion bearings are integrated.

The stainless steel rails (4) support the construction and are anchored outside the pool, providing rigidity and stability.

The final form and shape of the lift (drawing 1) allows its support and anchoring outside the water, which makes installation possible even when a pool is filled.
The lift is entirely made of stainless steel metal sheets and pipes.
The motor is low-voltage, 12 v or 24V, for safety reasons, and its power supply is at a safe distance from water.
The controller (6) is waterproof—of temporary submersion, it is installed on the rails of the platform and is moving on a vertical pipe, so as to be low when the platform is outside the water, but also to remain above water surface when the platform is submerged in order to serve wheelchair users more easily.
Two types of safety switches are installed:

a) one electronic revolution counter on the reducer,

b) mechanic switches outside the water determining the upper and bottom motion point of the platform. After the power supply section, a battery is installed in case of power failure; there is also a socket (manual override), on the reducer, for a manually operated crank in the event of motor lock.

1. The lift of autonomous access to a pool for persons with reduced mobility, comprising a platform with integrated rails (1), a motion endless screw (2), motion drives (3), support rails (4), a drive motor (5) and a controller (6), moves vertically and offers persons with reduced mobility access to a pool.

2. According to claim 1 the lift of autonomous access to a pool for persons with reduced mobility is made of stainless steel and waterproof materials.

3. According to claim 1 the lift of autonomous access to a pool for persons with reduced mobility can be used by the said persons without the assistance of another lift operator or a third person more than they would normally need for their routine transport and activities.

4. According to claim 1 the lift of autonomous access to a pool for persons with reduced mobility runs with a low voltage motor at 12 v or 24 v for safety reasons.

5. According to claim 1, the lift of autonomous access to a pool for persons with reduced mobility is connected to a 12 v or 24 v battery as an alternative drive solution in the event of power failure.

6. According to claim 1, the lift of autonomous access to a pool for persons with reduced mobility is connected to a manually operated crank at the motor reducer (5) as an alternative drive solution in case the motor is locked.

7. According to claim 1, for the lift of autonomous access to a pool for persons with reduced mobility both lateral and frontal access is foreseen.

8. According to claim 1, the lift of autonomous access to a pool for persons with reduced mobility is intended for persons with disabilities using a wheelchair or persons with reduced mobility.

9. According to claim 1, the lift of autonomous access to a pool for persons with reduced mobility is also intended for persons without any mobility problems as a bench which is semi-submerged into water.

10. According to claim 1, the lift of autonomous access to a pool for persons with reduced mobility is anchored outside the pool and there is no need to empty the pool for its installation.
